(19) United States
(12) Patent Application Publication
(10) Pub. No.: US 2013/0224554 A1
(43) Pub. Date: Aug. 29, 2013

(54) SEPARATOR INCLUDING COATING LAYER CONTAINING POLYIMIDE, AND BATTERY INCLUDING THE SAME

(71) Applicants: Ki Chul HONG, Uiwang-si (KR); Myung Kook PARK, Uiwang-si (KR); Jin Kyu PARK, Uiwang-si (KR); Jae Goo DOH, Uiwang-si (KR); Jun Ho CHUNG, Uiwang-si (KR)

(72) Inventors: Ki Chul HONG, Uiwang-si (KR); Myung Kook PARK, Uiwang-si (KR); Jin Kyu PARK, Uiwang-si (KR); Jae Goo DOH, Uiwang-si (KR); Jun Ho CHUNG, Uiwang-si (KR)

(21) Appl. No.: 13/778,354

(22) Filed: Feb. 27, 2013

(30) Foreign Application Priority Data
Feb. 29, 2012 (KR) 10-2012-0021142

(51) Int. Cl. H01M 2/16

(52) U.S. Cl. CPC H01M 2/1686
USPC 429/144

(57) ABSTRACT

A separator includes a base film and a coating layer on one or both sides of the base film, the coating layer being formed using a coating agent including a polyimide, an organic binder, and a solvent. A remaining amount of the solvent in the separator is about 100 ppm or less.

### CROSS-REFERENCE TO RELATED APPLICATION

Korean Patent Application No. 10-2012-0021142 filed on Feb. 29, 2012, in the Korean Intellectual Property Office, and entitled: “SEPARATOR INCLUDING COATING LAYER OF ORGANIC AND INORGANIC MIXTURE CONTAINING POLYIMIDE, AND BATTERY INCLUDING THE SAME,” is incorporated by reference herein in its entirety.

### BACKGROUND

1. Field

Embodiments relate to a separator including a coating layer containing a polyimide, and a battery including the same. 2. Description of the Related Art

A separator for an electrochemical battery refers to a middle layer disposed inside a battery to isolate a positive electrode and a negative electrode from each other while maintaining ionic conductivity to permit charge and discharge of the battery.

It may be beneficial for electrochemical batteries to have a lighter and thinner structure to improve portability of electronic devices such as, e.g., mobile devices and notebook computers while ensuring high output and high capacity for use in, e.g., electric cars and the like. Consequently, it may be desirable for a separator for batteries to have a slim thickness and a light weight while ensuring shape stability based on high heat resistance in order to produce high capacity batteries.

### SUMMARY

Embodiments are directed to a separator including a base film, and a coating layer on one or both sides of the base film, the coating layer being formed using a coating agent including a polyimide, an organic binder, and a solvent. The remaining amount of the solvent in the separator may be about 100 ppm or less.

The base film may be a polyolefin film.

The polyolefin base film may include one selected from the group of a polyethylene monolayer film, a polypropylene monolayer film, a polyethylene/polypropylene bilayer film, a polypropylene/polyethylene/polypropylene triple-layer film, and a polyethylene/polypropylene/polyethylene triple-layer film.

The polyimide may include a soluble polyimide.

The soluble polyimide may include one or more of repeat units represented by Formulae 1 or 2:

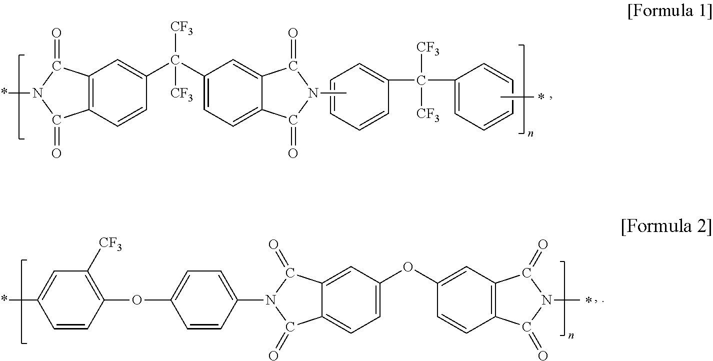

In Formulae 1 and 2, * and *′ may represent bonding sites of the repeat unit in the polyimide, and n may be an integer greater than or equal to 1.

The soluble polyimide may include one or more of repeat units represented by

Formula 3:

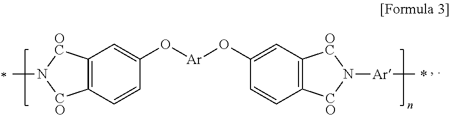

In Formula 3, * and *′ may represent bonding sites of the repeat unit in the polyimide, n may be an integer greater than or equal to 1, and Ar may include one or more groups represented by Formulae (a), (b), or (c), and Ar′ may include one or more groups represented by Formulae (x), (y), or (z):

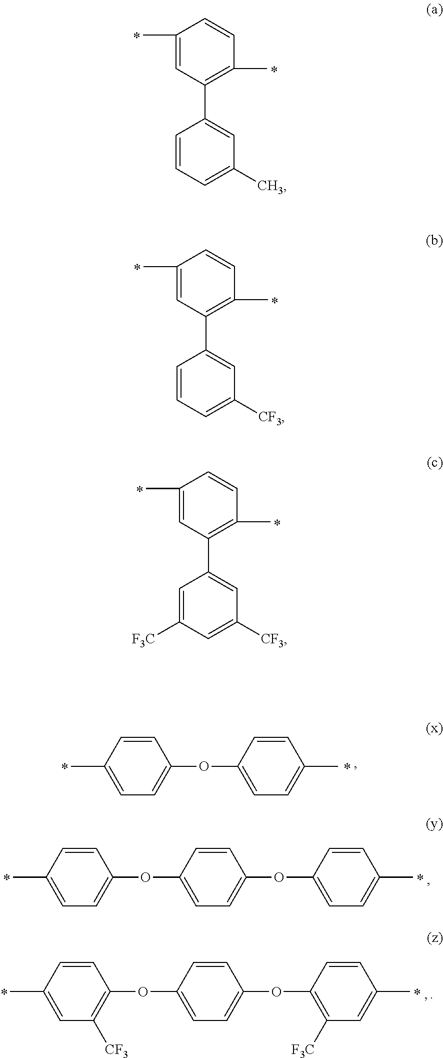

In Formulae (a), (b), (c), (x), (y), and (z), * and *′ may represent bonding sites of Ar and Ar′ in Formula 3.

The polyimide may include a trifluoromethyl group.

The organic binder may include an expandable organic binder.

The expandable organic binder may include a polyvinylidene fluoride-hexafluoropropylene copolymer.

The coating layer may include inorganic particles.

The inorganic particles may include at least one selected from the group of Al₂O₃, SiO₂, B₂O₃, Ga₂O₃, TiO₂ and SnO₂ particles.

The coating layer may be formed by dip coating.

The separator may have a thermal shrinkage of about 30% or less in a machine direction (MD) or in a transverse direction (TD), as measured after the separator is kept at 150° C. for 1 hour.

The separator may have a wettability of about 80 seconds or less.

Embodiments are also directed to an electrochemical battery including a positive electrode, a negative electrode, an electrolyte, and a separator, the separator may include a remaining amount of a solvent at about 100 ppm or less. The separator may include a base film and a coating layer on one or both sides of the base film, and the coating layer may be formed using a coating agent including a polyimide, an organic binder, and the solvent.

The solvent may have a boiling point of less than about 150° C.

The electrochemical battery may be a lithium rechargeable battery.

Embodiments are also directed to a separator including a base film and a coating layer on one or both sides of the base film, the coating layer being formed using a coating agent including a solvent having a boiling point of less than about 150° C., a polyimide, the polyimide being soluble in the solvent, and an organic binder.

The polyimide may include one or more of repeat units represented by Formulae 1, 2, or 3:

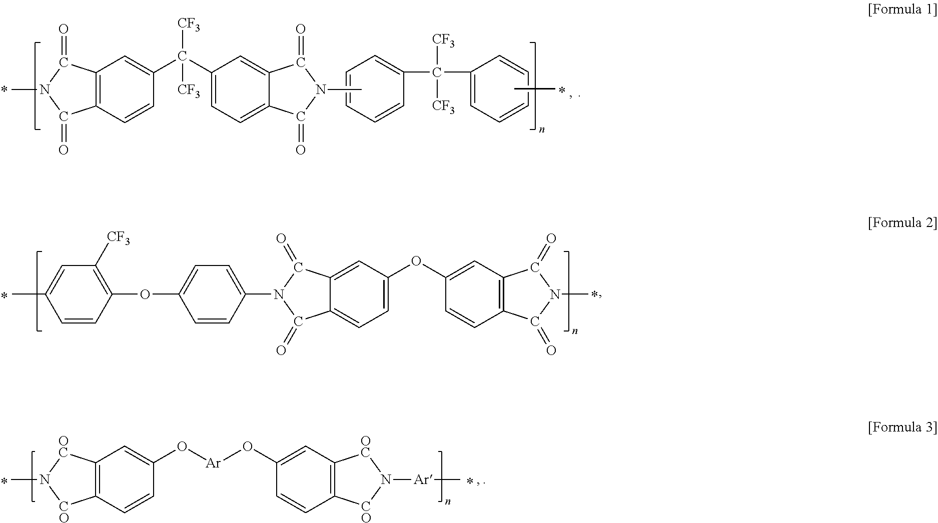

In Formulae 1, 2, and 3, * and *′ may represent bonding sites of the repeat unit in the polyimide, and n may be an integer greater than or equal to 1. In Formula 3, Ar may include one or more groups represented by Formulae (a), (b), or (c), and Ar′ may include one or more groups represented by Formulae (x), (y), or (z):

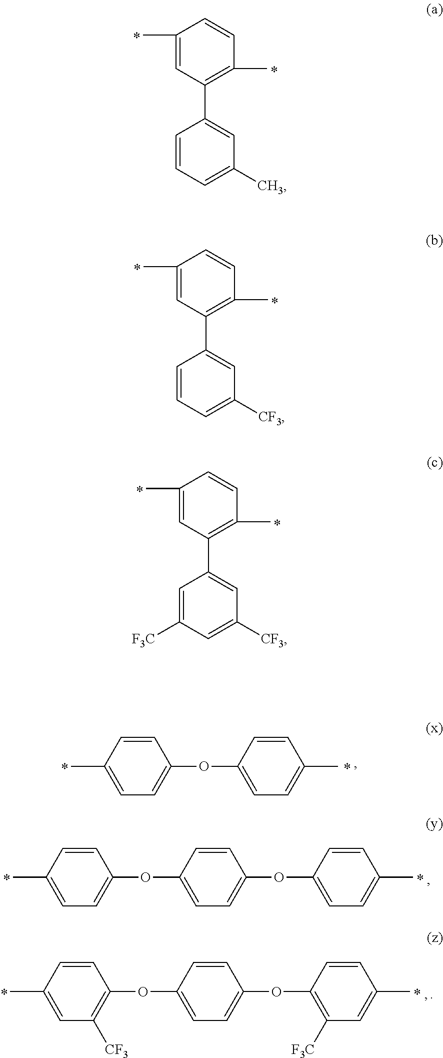

In Formulae (a), (b), (c), (x), (y), and (z), * and *′ may represent bonding sites of

Ar and Ar′ in Formula 3.

The organic binder may include at least one selected from the group of a polyvinylidene fluoride-hexafluoropropylene copolymer, a perfluoropolymer, a polyvinyl chloride and copolymers thereof, a polyvinylidene chloride and copolymers thereof, a polyethylene glycol derivative including polyethylene glycol dialkylether and polyethylene glycol dialkylester, a polyoxide including poly(oxymethylene-oligo-oxyethylene), a polyethylene oxide, a polypropylene oxide, a polyacrylonitrile copolymer including polyvinylacetate, a poly(vinylpyrrolidone-vinylacetate), a polystyrene, a polystyrene acrylonitrile copolymer, a polyacrylonitrile, a polyacrylonitrile methylmethacrylate copolymer, a polymethylmethacrylate, and a polymethylmethacrylate copolymer.

### BRIEF DESCRIPTION OF THE DRAWING

Features will become apparent to those of skill in the art by describing in detail exemplary embodiments with reference to the attached drawing in which:

FIG. 1 illustrates an electrochemical battery according to an embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art. In the drawing figure, the dimensions of layers and regions may be exaggerated for clarity of illustration. It will also be understood that when a layer or element is referred to as being “on” another layer or substrate, it can be directly on the other layer or substrate, or intervening layers may also be present.

According to an embodiment, a separator may include a coating layer formed on one or both sides of a base film using a coating agent containing polyimide, an organic binder, and a solvent, wherein the remaining amount of the solvent in the separator is about 100 ppm or less.

The polyimide may be a soluble polyimide. Herein, the soluble polyimide refers to a polyimide which can be more easily dissolved in a low boiling point solvent having a lower boiling point compared to an insoluble polyimide, and is not limited to a particular soluble polyimide. As used herein, the term “low boiling point solvent” refers to a solvent having a boiling point of less than 150° C., and the term “high boiling point solvent” refers to a solvent having a boiling point of 150° C. or more.

When the solvent remains in excess in the dried coating layer of the separator, the coating layer may exhibit low adhesion. Thus, a low boiling point solvent may be used as a solvent for the coating agent in a suitable coating process (e.g., dip coating).

However, an insoluble polyimide may have a problem in that it may not be dissolved in such a low boiling point solvent. Moreover, a polyimide generally may be incompatible with expandable organic binder components, which may be advantageously used together in terms of impregnation for an electrolyte of the coating layer.

In the embodiments, the soluble polyimide may be used as a component for the coating layer to be formed on the base film, and thus may overcome problems in the art. As the soluble polyimide, a suitable polyimide soluble in a low boiling point solvent may be used without limitation. Examples of the soluble polyimide may include fluoro-polyimide, polyether imide, and the like. Particularly, the fluoro-polyimide may be a trifluoromethyl group containing polyimide. The trifluoromethyl group may have a bulky structure to enlarge a free volume, and thus the trifluoromethyl group containing polyimide may be more easily dissolved in the low boiling point solvent.

In an embodiment, the trifluoromethyl group containing polyimide may include one or more of repeat units represented by Formulae 1 or 2.

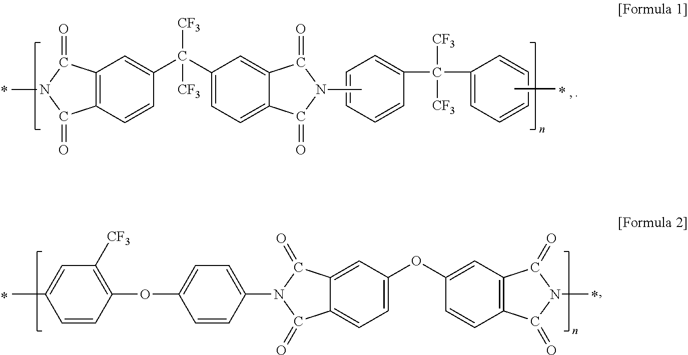

In Formulae 1 and 2, * and *′ may represent bonding sites of the repeat unit in the polyimide, and n may be an integer greater than or equal to 1.

In an embodiment, the polyether imide may include one or more of repeat units represented by Formula 3.

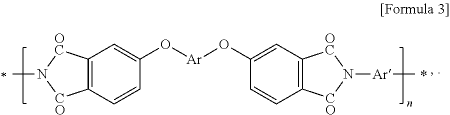

In Formula 3, * and *′ may represent bonding sites of the repeat unit in the polyimide, n may be an integer greater than or equal to 1, Ar may include one or more groups represented by Formulae (a), (b), or (c), and Ar′ may include one or more groups represented by Formulae (x), (y), or (z):

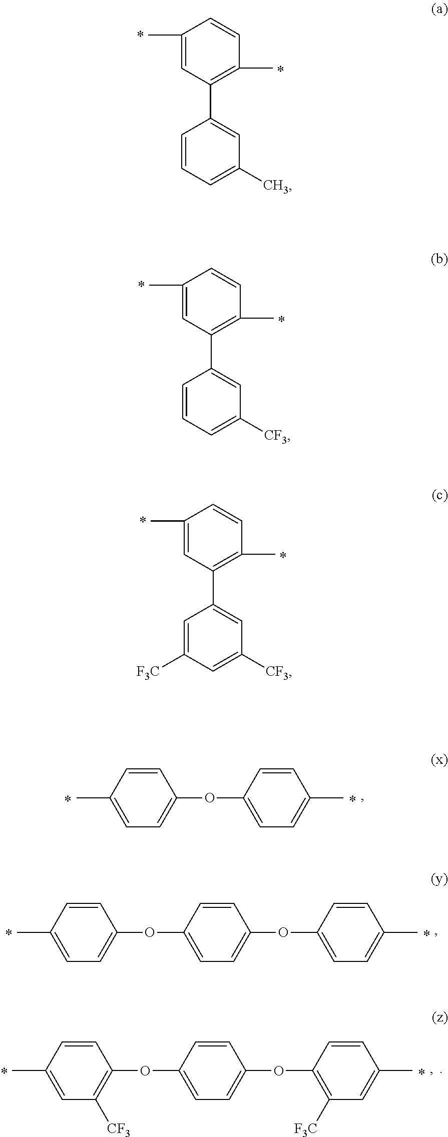

In Formula (a), (b), (c), (x), (y), and (z), * and *′ may represent bonding sites of Ar and Ar′ in Formula 3.

According to an embodiment, the organic binder may be an expandable organic binder. Herein, the expandable organic binder may refer to an organic binder component that is used as a component of the coating layer to enlarge an electrolyte supplementing capability of the separator and exhibits expandable properties with respect to the electrolyte. That is, the expandable organic binder may allow for increased impregnation and/or wetting of the electrolyte in the separator.

A suitable expandable organic binder having electrochemical stability and affinity with battery electrolytes may be used without limitation as the expandable organic binder. Examples of the expandable organic binder may include a polyvinylidene fluoride-hexafluoropropylene copolymer, a perfluoropolymer, a polyvinyl chloride or a polyvinylidene chloride and copolymers thereof, a polyethylene glycol derivative including polyethylene glycol dialkylether and polyethylene glycol dialkylester, a poly oxide including poly(oxymethylene-oligo-oxyethylene), a polyethylene oxide, a polypropylene oxide, a polyacrylonitrile copolymer including polyvinylacetate, a poly(vinylpyrrolidone-vinylacetate), a polystyrene, a polystyrene acrylonitrile copolymer, a polyacrylonitrile, a polyacrylonitrile methylmethacrylate copolymer, a polymethylmethacrylate, a polymethylmethacrylate copolymer, and the like. These may be used alone or in combination thereof.

According to an embodiment, the expandable organic binder may be a polyvinylidene fluoride-hexafluoropropylene copolymer. The polyvinylidene fluoride-hexafluoropropylene copolymer may have a weight average molecular weight of about 600,000 g/mol to about 800,000 g/mol. Within this molecular weight range of the polyvinylidene fluoride-hexafluoropropylene copolymer, the separator may allow for excellent electrolyte impregnation, and thus a battery including the separator may achieve efficient output of electricity.

In the polyvinylidene fluoride-hexafluoropropylene copolymer, although the content of each of polyvinylidene fluoride and hexafluoropropylene is not particularly limited, hexafluoropropylene may be present in an amount of about 0.1 to about 40% by weight based on the total weight of the copolymer.

The coating layer may further include the inorganic particles. According to an embodiment, the inorganic particles may be selected from the group of Al₂O₃, SiO₂, B₂O₃, Ga₂O₃, TiO₂ and SnO₂, without being limited thereto. These may be used alone or in combination thereof. The inorganic particles may be Al₂O₃ particles. Although not particularly limited to a certain average particle size (diameter), the inorganic particles may have, e.g., an average particle size from about 1 nm to about 2,000 nm, or from about 100 nm to about 1,000 nm. Within this size range, the inorganic particles may substantially reduce deterioration in coating processibility and dispersion within the coating agent, deterioration in mechanical properties, and increase in electric resistance by allowing suitable thickness adjustment of the coating layer through increase in density of the coating layer. Further, pores of a suitable size may be created in the coating layer, thereby lowering the likelihood of internal short circuit upon charge and discharge of the battery.

According to an embodiment, the coating agent of the organic and inorganic mixture may contain the polyimide and the organic binder as organic binder polymer resins, and the inorganic particles. The coating agent may further contain suitable solvents and other additives.

Although not particularly limited to a certain ratio in the coating layer of the organic and inorganic mixture, the coating layer may contain: about 5 to about 10 parts by weight of the polyimide; about 5 to about 20 parts by weight of the organic binder; and about 70 to about 90 parts by weight of the inorganic particles, based on 100 parts by weight of the coating layer. Within these ranges, the polyimide may provide improved heat resistance and adhesion, the inorganic particles may provide improved heat dissipation, and the organic binder may permit sufficient impregnation of the electrolyte, whereby the coating layer may be formed in a relatively flat shape by substantially reducing deterioration in coating processibility and dispersion of the coating agent.

In preparation of the coating agent according to an embodiment, the polyimide, the organic binder, and the inorganic particles may be dissolved in suitable solvents, respectively, and mixed with each other. In an embodiment, the polyimide and the organic binder, for example, a polyvinylidene fluoride-hexafluoropropylene copolymer, may be prepared as polymer solutions, which may be obtained by dissolving the polyimide and the polyvinylidene fluoride-hexafluoropropylene copolymer in acetone. Further, the inorganic particles may be prepared as an inorganic dispersion, which may obtained by dissolving and/or dispersing the inorganic particles in acetone.

The polymer solutions and the inorganic dispersion may be mixed in a suitable solvent to prepare a coating agent. Examples of solvents include ketones such as acetone, or alcohols such as methanol, ethanol, isopropyl alcohol, and the like, without being limited thereto. These solvents may provide an advantage of allowing easy removal upon drying after coating. According to an embodiment, the coating agent may be prepared in the form of a mixture obtained by sufficiently stirring the polymer solutions, the inorganic dispersion and the solvent using a ball mill, a bead mill or a screw mixer.

The separator according to an embodiment may be prepared by coating the coating agent on one or both sides of a base film, followed by drying the coating agent. A suitable coating method may be used without limitation in order to coat the base film with the coating agent. For example, dip coating, die coating, roll coating, or comma coating may be used. These coating processes may be used alone or in combination thereof. The coating layer of the separator may be formed by dip coating.

According to an embodiment, the coating layer including an organic and inorganic mixture may have a thickness of, e.g., about 0.01 μtm to about 20 μm, or about 1 μm to about 15 μm. Within this thickness range, the coating layer may be formed to a suitable thickness to have excellent thermal stability and adhesion, and may substantially prevent the separator from being excessively thickened, thereby substantially preventing an increase in internal resistance of the battery.

According to an embodiment, the base film may be a polyolefin base film. For example, the polyolefin base film may be selected from the group of a polyethylene monolayer film, a polypropylene monolayer film, a polyethylene/polypropylene bilayer film, a polypropylene/polyethylene/polypropylene triple-layer film, and a polyethylene/polypropylene/polyethylene triple-layer film.

The polyolefin base film may have a thickness of about 1 μm to about 40 μm, or about 1 μm to about 25 μm. Within this thickness range of the base film, the separator may be formed to a suitable thickness, thereby substantially reducing a short circuit of the positive electrode and the negative electrode while improving stability of the battery. If the thickness of the separator exceeds this range, there may be an increase in internal resistance of the battery.

The separator including the coating layer of the organic and inorganic mixture may have a thermal shrinkage of about 30% or less in a machine direction (MD) or in a transverse direction (TD), as measured after leaving the separator at 150° C. for 1 hour. Within this range, the separator may substantially reduce short circuiting of the electrodes, thereby improving stability of the battery.

Here, a suitable method may be used without limitation to measure the thermal shrinkage of the separator. For example, the thermal shrinkage of the separator may be measured as follows: a prepared separator is cut into a size of about 5 cm (width) x about 5 cm (length) and left in a chamber at 150° C. for 1 hour, followed by measuring degrees of shrinkage in MD and TD directions to calculate thermal shrinkage.

In an embodiment, the separator may have an electrolyte wettability of 80 seconds or less. Herein, the electrolyte wettability refers to a period of time from a time point of leaving a separator having a predetermined size (for example, a circular separator specimen having an outer diameter of 18 mm) on a surface of an electrolyte in a beaker to a time point when the separator is completely wet by the electrolyte.

As the electrolyte of the battery according to an embodiment, a suitable electrolyte for electrochemical batteries may be used without limitation. The electrolyte may be obtained through dissolution or dissociation of a salt having, for example, a structure of A⁺ B⁻ in an organic solvent. Examples of the A⁺ component, that is, the cation, may include alkali metal cations such as Li⁺, Na⁺ or K⁺, and combinations thereof, without being limited thereto. Examples of the B− component, that is, the anion, may include PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, C(CF₂SO₂)₃⁻, and combinations thereof, without being limited thereto. In some embodiments, the separator may have a remaining solvent amount of about 100 ppm or less. Herein, the remaining solvent amount of about 100 ppm or less technically does not mean a numerical value of 0 or less and is a positive value that exceeds 0 and is less than or equal to about 100 ppm. The remaining amount of the solvent may exceed about 10 ppm and may be less than or equal to about 100 ppm.

The remaining solvent amount may be measured by depositing the coating agent on one side of the base film, followed by drying at temperatures of about 90° C. to about 120° C. for about 5 seconds to about 2 minutes, for example at 100° C. for 10 seconds. When the remaining solvent amount in the separator is 100 ppm or less, it is possible to substantially prevent and/or reduce various problems that may be caused by an excess of the solvent remaining in the separator, that is, e.g., insufficient demonstration of adhesion by the organic binder component, insufficient suppression of thermal shrinkage of the base film due to deterioration in adhesion of the coating layer, short circuit between electrodes upon overheating of the battery due to deterioration in performance of the battery upon charge and discharge of the battery, and the like. In accordance with an embodiment, the separator may have a solvent remaining amount of about 100 ppm or less, as measured by coating one side of a base film with a coating agent containing polyimide and an organic binder, and drying the coating agent at about 100° C. for about 10 seconds.

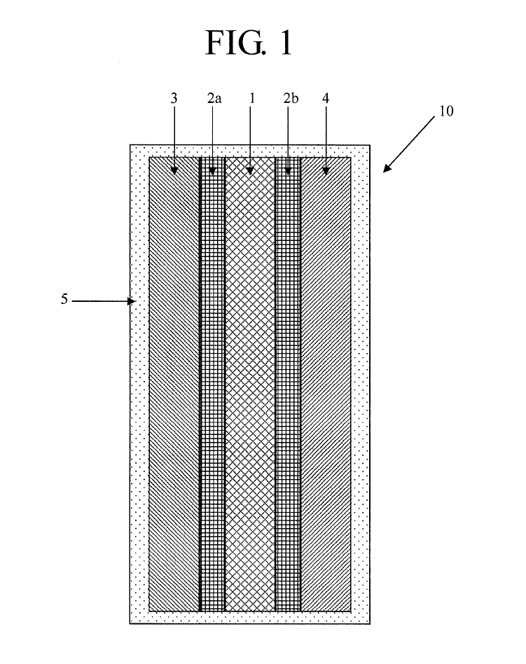

In accordance with an embodiment, an electrochemical battery may include a polyolefin porous separator including the coating layer, a positive electrode, and a negative electrode, and the electrochemical battery may be filled with an electrolyte. FIG. 1 illustrates an electrochemical battery 10 according to an embodiment. The electrochemical battery 10 may include a separator including a base film 1, a coating layer 2a and 2b on both sides of the base film 1 (although the coating layer may also be on only one side of the base film), a positive electrode 3, a negative electrode 4, and an electrolyte 5. The electrochemical battery 10 of FIG. 1 is merely a representation and various elements that may be included in the electrochemical battery 10 (e.g., a case, a cap plate, terminals, etc.) are not illustrated. A suitable type of electrochemical battery may be used without limitation. Examples of the electrochemical battery may include lithium rechargeable batteries, such as lithium metal rechargeable batteries, lithium ion rechargeable batteries, lithium polymer rechargeable batteries, lithium ion polymer rechargeable batteries, and the like.

A suitable method may be used without limitation to manufacture the electrochemical battery according to the embodiments. For example, the electrochemical battery may be manufactured by placing the polyolefin separator including the coating layer between a positive electrode and a negative electrode, and filling a space therebetween with an electrolyte. The electrodes of the electrochemical battery may be prepared in the form of assemblies of electrode active materials and current collectors, which may combined by a suitable method.

As the positive active material of the battery, a suitable positive electrode active material may be used without limitation. Examples of the positive electrode active material may include lithium manganese oxides, lithium cobalt oxides, lithium nickel oxides, lithium iron oxides, and lithium composite oxides thereof, without being limited thereto.

Further, as the negative electrode active material of the battery a suitable negative electrode active material may be used without limitation. Examples of the negative electrode active material may include lithium metal, lithium alloys, lithium adsorption materials such as carbon, petroleum coke, activated carbon, graphite and other carbonous materials, and the like.

As the current collector of the battery, a suitable current collector may be used without limitation. Examples of a positive electrode current collector may include aluminum foils, nickel foils, and combinations thereof, without being limited thereto. Examples of a negative electrode current collector may include copper foils, gold foils, nickel foils, copper alloy foils, and combinations thereof, without being limited thereto.

As the electrolyte of the battery, a suitable electrolyte for electrochemical batteries may be used without limitation. The electrolyte may be obtained through dissolution or dissociation of a salt having, for example, a structure of A⁺ B⁻ in an organic solvent. Examples of the A⁺ component, that is, the cation, may include alkali metal cations such as Li⁺, Na⁺ or K⁺, and combinations thereof, without being limited thereto. Examples of the B⁻ component, that is, the anion, may include PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, C(CF₂SO₂)₃⁻, and combinations thereof, without being limited thereto.

Examples of the organic solvent may include propylene carbonate (PC), ethylene carbonate (EC), diethylcarbonate (DEC), dimethylcarbonate (DMC), dipropylcarbonate (DPC), dimethylsulfoxi de, acetonitrile, dimethoxyethane, diethoxyethane, tetrahydrofuran, N-methyl-2-pyrrolidone (NMP), ethylmethylcarbonate (EMC), γ-butyrolactone, and the like. These may be used alone or in combination thereof.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1 and Comparative Examples 1 to 3

Preparation of separator including coating layer containing soluble polyimide.

### Example 1

(1) Preparation of Coating Agent

1) A polyvinylidene fluoride-hexafluoropropylene (PVdF-HFP) copolymer (21216, SOLVAY) having a weight average molecular weight of 700,000 g/mol was added in an amount of 10 wt% to acetone (DAEJUNG CHEMICALS & METALS), followed by stirring at 25° C. for 4 hours using a stirrer to prepare a first polymer solution.

2) A polyimide (CHEIL INDUSTRIES) having a weight average molecular weight of 50,000 g/mol was added in an amount of 10 wt % to acetone (DAEJUNG CHEMICALS & METALS), followed by stirring at 25° C. for 4 hours using a stirrer to prepare a second polymer solution.

3) Al₂O₃ particles (LS235, NIPPON LIGHT METAL COMPANY) were added in an amount of 25 wt % to acetone (DAEJUNG CHEMICALS & METALS), followed by milling for dispersion at 25° C. for 3 hours using a bead mill to prepare an inorganic dispersion.

The prepared first polymer solution, second polymer solution and inorganic dispersion were mixed in a ratio of first polymer solution:second polymer solution:inorganic dispersion:solvent (acetone) of 1.8:0.2:3:6, and stirred at 25° C. for 2 hours using a power mixer to prepare a coating agent.

(2) Preparation of Separator

The prepared coating agent was deposited on both sides of a 9 μm thick polyethylene monolayer base film by dip coating and dried at a temperature of 100° C. for 10 seconds to prepare a separator.

### Example 2

A separator was prepared in the same manner as in Example 1 except that the coating agent was prepared by mixing the first polymer solution, the second polymer solution, the inorganic dispersion and solvent (acetone) in a ratio of 1.4:0.4:3:6.

### Example 3

A separator was prepared in the same manner as in Example 1 except that the coating agent was prepared by mixing the first polymer solution, the second polymer solution, the inorganic dispersion and solvent (acetone) in a ratio of 1:1:3:6.

### Comparative Example 1

Preparation of Separator Including Coating Layer Containing Insoluble Polyimide

An insoluble polyimide was used instead of the soluble polyimide in preparing the second polymer solution of Example 1; however, the insoluble polyimide was not dissolved in acetone. As a result, the coating agent could not be prepared.

### Comparative Example 2

Preparation of Separator Including Coating Layer Free From Soluble Polyimide

(1) Preparation of Coating Agent

1) A polyvinylidene fluoride-hexafluoropropylene (PVdF-HFP) copolymer (21216, SOLVAY) having a weight average molecular weight of 700,000 g/mol was added in an amount of 10 wt % to acetone (DAEJUNG CHEMICALS & METALS), followed by stirring at 25° C. for 4 hours using a stirrer to prepare a first polymer solution.

2) Al₂O₃ particles (LS235, NIPPON LIGHT METAL COMPANY) were added in an amount of 25 wt % to acetone (DAEJUNG CHEMICALS & METALS), followed by milling for dispersion at 25° C. for 3 hours using a bead mill to prepare an inorganic dispersion.

The prepared first polymer solution and inorganic dispersion were mixed in a ratio of first polymer solution:inorganic dispersion:solvent (acetone) of 2:3:6, and stirred at 25° C. for 2 hours using a power mixer to prepare a coating agent.

(2) Preparation of Separator

The prepared coating agent was deposited on both sides of a 9 μm thick polyethylene monolayer base film by dip coating and dried to prepare a separator.

### Comparative Example 3

Preparation of Separator Including Coating Layer Free From PVdF-HFP Copolymer

A separator was prepared in the same manner as in Example 1 except that a polyvinylidene fluoride homopolymer (5130, SOLVAY) was added in an amount of 10 wt % to DMF (DAEJUNG CHEMICALS & METALS) to prepare a first polymer solution.

### Experimental Example 1

Measurement of Thickness and Loading Amount of Coating Layer

The thickness and loading amount of each of the coating layers prepared in Examples 1 to 3 and Comparative Examples 2 and 3 were measured as follows.

First, the thickness of each coating layer was measured using an SEM cross section image and a microcaliper. Then, each of the coating layers was cut into 10 cm (MD)×20 cm (TD) pieces to prepare specimens, each weight of which was measured using an electronic scale, followed by calculating the loading amount of the coating agent. The phrase “loading amount of coating agent (or coating layer)” means a weight per unit area of the coating layer. The calculation results of the thicknesses and the loading amounts are listed in Table 1.

### Experimental Example 2

Measurement of Thermal Shrinkage of Separator

Each of the separators prepared in Examples 1 to 3 and Comparative Examples 2 and 3 was cut into 5 cm (MD) x 5 cm (TD) pieces to prepare a total of 5 specimens. Each of the specimens was left in a chamber at 150° C. for 1 hour, followed by measuring degrees of shrinkage of each specimen in MD and TD directions to calculate thermal shrinkage. Measurement results of the thermal shrinkage are listed in Table 1 (below).

### Experimental Example 3

Measurement of Electrolyte Wettability

Each of the separators prepared in Examples 1 to 3 and Comparative Examples 2 and 3 was cut into circular pieces each having an outer diameter of 18 Φ to prepare a total of 5 specimens. Then, each specimen was placed on the surface of the electrolyte in a beaker until the specimen was completely wet by the electrolyte. Here, a period of time from a time point of placing the specimen on the surface of the electrolyte to a time point when the specimen was completely wet by the electrolyte was measured. Periods of time taken for wetting the specimens by the electrolyte are listed in Table 1.

TABLE 1

| | | | Thermal | | |
|---|---|---|---|---|---|
| | Thickness | | shrinkage of | | Electrolyte |
| | of coating | Loading | separator (%) | | Wettability |
| | layer (μm) | amount (g/m²) | TD | MD | (sec) |
| Example 1 | 4.5 | 7.9 | 9.5 | 15.0 | 63 |
| Example 2 | 4.4 | 8.1 | 8.5 | 12.5 | 51 |
| Example 3 | 4.6 | 8.2 | 7.0 | 9.5 | 32 |
| Comparative | 4.3 | 8.1 | 21.5 | 25.0 | 85 |
| Example 2 | | | | | |
| Comparative | 4.6 | 8.3 | 5.0 | 7.0 | 187 |
| Example 3 | | | | | |

As shown in Table 1, the separators of Examples 1 to 3 each including the coating layer containing the soluble polyimide had lower thermal shrinkage than the separators of Comparative Example 2 including the coating layer free from the soluble polyimide. Thus, it can be confirmed that the separators of Examples 1 to 3 have improved thermal stability.

Further, in Comparative Example 3 wherein the PVdF-HFP copolymer was not used under the same conditions as in Example 1, it was determined that the separator had significantly deterioration in electrolyte wettability.

### Experimental Example 4

Measurement of Remaining Amount of Solvent in Separator

Each of the separators prepared in Examples 1 to 3 was analyzed through gas-chromatography (HP-6890) under conditions as listed in Table 2 to measure the amount of the solvent remaining in the separator.

TABLE 2

| Parameter | Condition |
|---|---|
| Column | Front: HP-INNOWax (length 30M, ID 0.53 mm, |
| | Film thickness 1.00 μm) |
| | Back: HP-1 (length 30M, ID 0.53 mm, |
| | Film thickness 0.88 μm) |
| Temperature and time | 40° C. (4 min) → 20° C./ |
| | min → 250° C. (4 min) |
| Flow rate | 10 mL/min |
| Injector | S/SL Injector |
| Split ratio | 5:1 |
| Detector | FID |
| Injection volume | 1 μl |
| Injector temperature | 200° C. |

According to results of the gas-chromatography, the remaining amount of acetone in each of the separators prepared in Examples 1 to 3 was less than about 50 ppm.

By way of summary and review, it may be desirable for an organic binder having excellent heat resistance to be used as an organic binder component of a coating agent for a separator, e.g., so that the coating layer can exhibit further improved thermal stability. However, the organic binder having high heat resistance may not be dissolved in a low boiling point solvent that may be used for forming the coating layer and may have low compatibility with other components of the coating agent. Heat resistance of the separator may be an important factor relating to stability and lifespan of a battery. Thus, it may be desirable for a separator to include a coating layer that has excellent thermal stability through use of a heat resistant organic binder.

The separator according to the embodiments may allow for improvements related to the above-described issues. According to an embodiment, the separator may employ a polyimide that is capable of being easily dissolved in a low boiling point solvent and that is compatible with other components (e.g., the organic binder) of the coating agent, and thus the separator may have excellent heat resistance to allow for reduction of thermal shrinkage. Further, when applied to a battery, the separator may reduce short circuiting of the electrodes by reducing thermal shrinkage of the battery upon overheating of the battery, thereby improving stability and lifespan of the battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A separator, comprising:
a base film; and
a coating layer on one or both sides of the base film, the coating layer being formed using a coating agent including:
a polyimide,
an organic binder, and
a solvent,
wherein a remaining amount of the solvent in the separator is about 100 ppm or less.

2. The separator as claimed in claim 1, wherein the base film is a polyolefin film.

3. The separator as claimed in claim 2, wherein the polyolefin base film includes one selected from the group of a polyethylene monolayer film, a polypropylene monolayer film, a polyethylene/polypropylene bilayer film, a polypropylene/polyethylene/polypropylene triple-layer film, and a polyethylene/polypropylene/polyethylene triple-layer film.

4. The separator as claimed in claim 1, wherein the polyimide includes a soluble polyimide.

5. The separator as claimed in claim 4, wherein the soluble polyimide includes one or more of repeat units represented by Formulae 1 or 2: 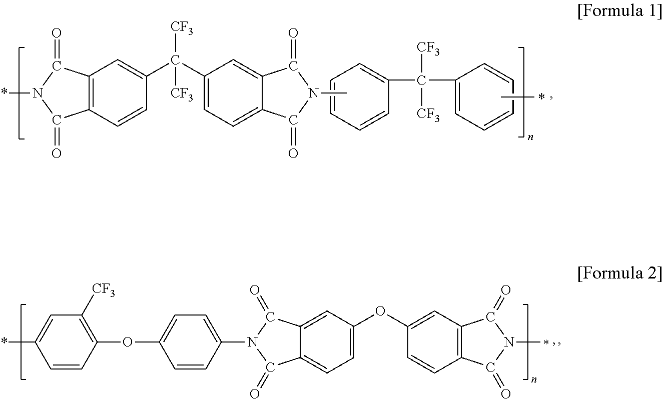
wherein, in Formulae 1 and 2,
* and *′ represent bonding sites of the repeat unit in the polyimide, and
n is an integer greater than or equal to 1.

6. The separator as claimed in claim 4, wherein the soluble polyimide includes one or more of repeat units represented by Formula 3: 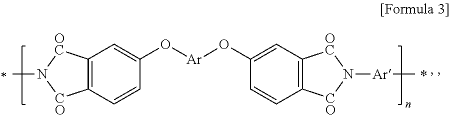
wherein, in Formula 3:
* and *′ represent bonding sites of the repeat unit in the polyimide,
n is an integer greater than or equal to 1, and
Ar includes one or more groups represented by Formulae (a), (b), or (c), and Ar′ includes one or more groups represented by Formulae (x), (y), or (z): 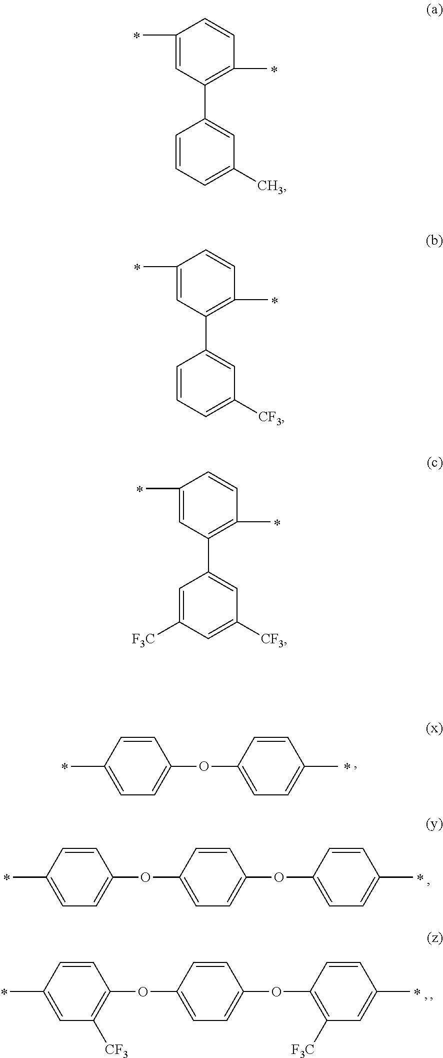
wherein, in Formulae (a), (b), (c), (x), (y), and (z), * and *′ represent bonding sites of Ar and Ar′ in Formula 3.

7. The separator as claimed in claim 1, wherein the polyimide includes a trifluoromethyl group.

8. The separator as claimed in claim 1, wherein the organic binder includes an expandable organic binder.

9. The separator as claimed in claim 8, wherein the expandable organic binder includes a polyvinylidene fluoride-hexafluoropropylene copolymer.

10. The separator as claimed in claim 1, wherein the coating layer includes inorganic particles.

11. The separator as claimed in claim 10, wherein the inorganic particles include at least one selected from the group of Al₂O₃, SiO₂, B₂O₃, Ga₂O₃, TiO₂ and SnO₂ particles.

12. The separator as claimed in claim 1, wherein the coating layer is formed by dip coating.

13. The separator as claimed in claim 1, wherein the separator has a thermal shrinkage of about 30% or less in a machine direction (MD) or in a transverse direction (TD), as measured after the separator is kept at 150° C. for 1 hour.

14. The separator as claimed in claim 1, wherein the separator has a wettability of about 80 seconds or less.

15. An electrochemical battery, comprising:
a positive electrode;
a negative electrode;
an electrolyte; and
a separator, the separator including a remaining amount of a solvent at about 100 ppm or less,
wherein:
the separator includes a base film and a coating layer on one or both sides of the base film, and
the coating layer is formed using a coating agent including:
a polyimide,
an organic binder, and
the solvent.

16. The electrochemical battery as claimed in claim 15, wherein the solvent has a boiling point of less than about 150° C.

17. The electrochemical battery as claimed in claim 15, wherein the electrochemical battery is a lithium rechargeable battery.

18. A separator, comprising:
a base film; and
a coating layer on one or both sides of the base film, the coating layer being formed using a coating agent including:
a solvent having a boiling point of less than about 150° C.,
a polyimide, the polyimide being soluble in the solvent, and
an organic binder.

19. The separator as claimed in claim 18, wherein the polyimide includes one or more of repeat units represented by Formulae 1, 2, or 3: 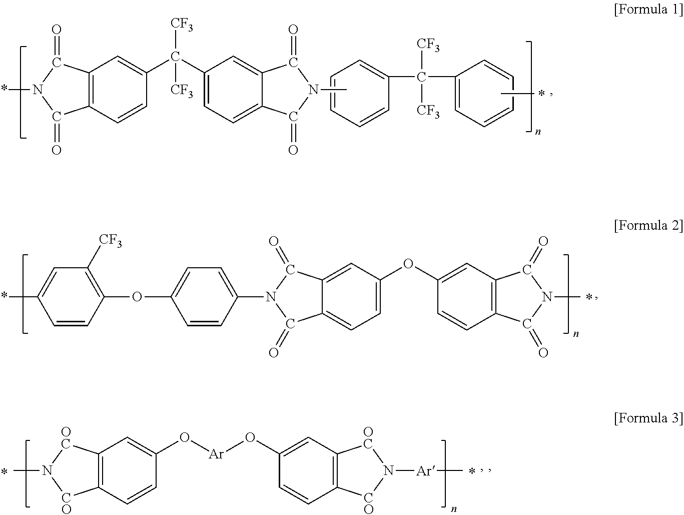
wherein, in Formulae 1, 2, and 3,
* and *′ represent bonding sites of the repeat unit in the polyimide, and
n is an integer greater than or equal to 1, and
wherein, in Formula 3:
Ar includes one or more groups represented by Formulae (a), (b), or (c), and Ar′ includes one or more groups represented by Formulae (x), (y), or (z): 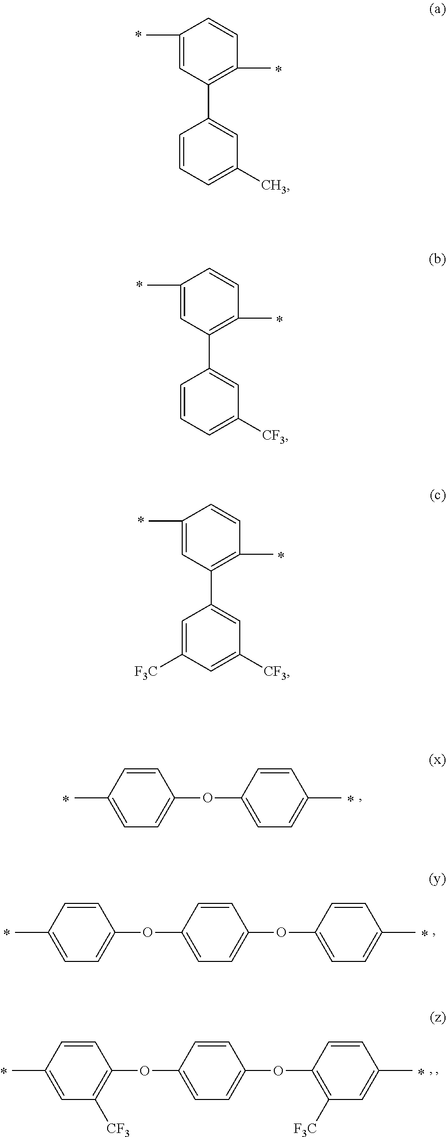
wherein, in Formulae (a), (b), (c), (x), (y), and (z), * and *′ represent bonding sites of Ar and Ar′ in Formula 3.

20. The separator as claimed in claim 19, wherein the organic binder includes at least one selected from the group of a polyvinylidene fluoride-hexafluoropropylene copolymer, a perfluoropolymer, a polyvinyl chloride and copolymers thereof, a polyvinylidene chloride and copolymers thereof, a polyethylene glycol derivative including polyethylene glycol dialkylether and polyethylene glycol dialkylester, a polyoxide including poly(oxymethylene-oligo-oxyethylene), a polyethylene oxide, a polypropylene oxide, a polyacrylonitrile copolymer including polyvinylacetate, a poly(vinylpyrrolidone-vinylacetate), a polystyrene, a polystyrene acrylonitrile copolymer, a polyacrylonitrile, a polyacrylonitrile methylmethacrylate copolymer, a polymethylmethacrylate, and a polymethylmethacrylate copolymer.
